(19) United States
(12) Patent Application Publication
(10) Pub. No.: US 2014/0266165 A1
(43) Pub. Date: Sep. 18, 2014

(54) TOOTH SENSING

(71) Applicant: Tiax LLC, Lexington, MA (US)

(72) Inventor: J. Thomas Fowler, Marblehead, MA (US)

(73) Assignee: Tiax LLC, Lexington, MA (US)

(21) Appl. No.: 14/209,077

(22) Filed: Mar. 13, 2014

Related U.S. Application Data
(60) Provisional application No. 61/780,057, filed on Mar. 13, 2013.

(51) Int. Cl. G01D 5/12

(52) U.S. Cl. CPC G01D 5/12
USPC 324/207.16; 324/207.25

(57) ABSTRACT

A rotational position sensing device includes at least one sensor positioned adjacent a rotating component configured to rotate about an axis of rotation. At least one magnet is positioned at the rotating component such that a magnetic field of the at least one magnet affects the sensor and magnetizes a portion of the rotating component. The at least one sensor is configured to produce an output signal indicative of a magnetic flux, and therefore a position, of the rotating component. A method of sensing a position of a rotating component includes magnetizing a portion of a rotating component with a magnet and measuring a magnetic flux of the rotating component as it rotates about an axis of rotation. An output signal is generated that is indicative of the position of the rotating component.

### CROSS REFERENCE TO RELATED APPLICATIONS

This application claims priority to U.S. provisional application 61/780,057 filed Mar. 13, 2013, the entire contents of which are incorporated herein by reference.

### BACKGROUND

The present disclosure relates generally to rotational components, such as gears for example, and, more particularly, to methods and sensors for detecting rotational position of a gear, ring, wheel, flexplate, or other rotational component.

Rotational position sensing of a rotating component may be used in a variety of applications including, but not limited to, angular speed measurement, distance traveled calculation, and absolute position encoding of the rotational component relative to, for example, a fixed component such as a hub or axle. It may also be used to determine a relative position of a first rotating component relative to a second rotating component, whose angular position is also sensed. Further, rotational position sensing may be utilized in other applications, for example, torque sensing, or calculation of applied torque. Thus there remains a need for improved methods of rotational position sensing.

### SUMMARY

In one embodiment, a rotational position sensing device includes at least one sensor positioned adjacent a rotating component configured to rotate about an axis of rotation. At least one magnet is positioned at the rotating component such that a magnetic field of the at least one magnet affects the sensor and magnetizes a portion of the rotating component. The at least one sensor is configured to produce an output signal indicative of a magnetic flux, and therefore a position, of the rotating component.

Additionally or alternatively, in this or other embodiments the rotating component includes a plurality of teeth extending about an outer periphery of the rotating component.

Additionally or alternatively, in this or other embodiments the at least one sensor is arranged generally perpendicular to and axially aligned with the teeth of the rotating component.

Additionally or alternatively, in this or other embodiments a spacing between a plurality of adjacent sensors is substantially equal to a spacing between a tooth of the plurality of teeth of the rotating component and an adjacent valley.

Additionally or alternatively, in this or other embodiments at least one detector is positioned adjacent the rotating component.

Additionally or alternatively, in this or other embodiments the at least one detector is configured to synchronize a detection method with the teeth of the rotating component.

Additionally or alternatively, in this or other embodiments an axial and a vertical position of the at least one magnet relative to the at least one sensor varies based on a strength of the at least one magnet and a sensitivity of the at least one sensor.

Additionally or alternatively, in this or other embodiments a plurality of demagnetizing magnets is positioned about an outer periphery of the rotating component. The demagnetizing magnets are configured to make the rotating component generally magnetically uniform.

Additionally or alternatively, in this or other embodiments the plurality of demagnetizing magnets are positioned to have an alternating polarity to form an alternating current degaussing pattern.

Additionally or alternatively, in this or other embodiments the at least one sensor is a fluxgate sensor.

Additionally or alternatively, in this or other embodiments the at least one sensor is a fluxgate sensor configured as an inductive pickup.

Additionally or alternatively, in this or other embodiments the at least one sensor is an inductive pickup.

Additionally or alternatively, in this or other embodiments the rotating component is positioned axially between the at least one sensor and the at least one magnet.

Additionally or alternatively, in this or other embodiments the at least one sensor is positioned at a first circumferential end of the rotating component, and the at least one magnet is positioned substantially 180 degrees away from the at least one sensor.

In another embodiment, a method of sensing a position of a rotating component includes magnetizing a portion of a rotating component with a magnet and measuring a magnetic flux of the rotating component as it rotates about an axis of rotation. An output signal is generated that is indicative of the position of the rotating component.

Additionally or alternatively, in this or other embodiments the magnetic flux is measured using at least one sensor positioned adjacent the rotating component.

Additionally or alternatively, in this or other embodiments the at least one sensor is a fluxgate sensor.

Additionally or alternatively, in this or other embodiments the measured magnetic flux is amplified to produce an amplified output signal.

These and other advantages and features will become more apparent from the following description taken in conjunction with the drawings.

### BRIEF DESCRIPTION OF THE DRAWINGS

The disclosed subject matter is particularly pointed out and distinctly claimed in the claims at the conclusion of the specification. The foregoing and other features, aspects, and advantages are apparent from the following detailed description taken in conjunction with the accompanying drawings in which:

FIG. 1 is a cross-sectional view of a tooth sensing device according to an embodiment;

FIG. 2 is a cross-sectional view of a tooth sensing device according to an embodiment;

FIG. 3 is a perspective view of a tooth sensing device according to an embodiment;

FIG. 4 is another perspective view of a tooth sensing device according to an embodiment;

FIG. 5 is a cross-sectional view of a tooth sensing device according to an embodiment;

FIG. 6 is a cross-sectional view of a tooth sensing device according to an embodiment;

FIG. 7 is an exemplary fluxgate output signal of the tooth sensing device according to an embodiment;

FIG. 8 is a side view of a tooth sensing device according to an embodiment;

FIG. 9 is a detailed view of a detector configured for use in conjunction with the tooth sensing device according to an embodiment;

FIG. 10 is a top view of a tooth sensing device according to an embodiment;

FIG. 11 is a cross-sectional view of a tooth sensing device according to an embodiment of the invention;

FIG. 12 is a schematic diagram of a circuit of a tooth sensing device according to an embodiment;

FIG. 13 is a schematic diagram of a circuit of a detector configured for use with the tooth sensing device according to an embodiment; and

FIG. 14 is a schematic view of an embodiment of a flux gate sensor configured for use as a tooth sensing device

### DETAILED DESCRIPTION

Detection of a tooth of a circular rotating component via a tooth sensing device 20 including fluxgate technology is generally improved by positioning a permanent magnet 25 in proximity to a fluxgate sensor 30 adjacent the rotating component 40 (see FIGS. 3 and 4) such that the magnetic field generated by the magnet 25 affects the teeth 45 of the rotating component 40 as well as the fluxgate sensors 30. As the teeth pass 45 through the magnetic field, the change between the presence and absence of a tooth 45 is detected by a fluxgate sensor 30. Referring now to FIGS. 1-4, the magnet 25 may be positioned near one or more fluxgate sensors 30, such as adjacent a first side 32 of the sensor 30 (FIG. 1) or adjacent a second, opposite side 34 of the sensor 30. The toothed rotating component 40 is oriented generally perpendicularly (see FIGS. 3 and 4). The axial and vertical position of the magnet 25 relative to the at least one fluxgate sensor 30 will vary based on the strength of the magnet 25 and the sensitivity of the fluxgate sensor 30. In an embodiment, the magnet 25 is positioned such that the output signal generated by the fluxgate sensor 30 has a high amplitude without system saturation. Magnets 25 that are similar in size to the pitch of the teeth 45 and the spacing between adjacent fluxgate sensors 30 generally create a fluxgate output signal having the strongest signal amplitude.

In another embodiment, illustrated in FIGS. 5 and 6, a first magnet 25 may be positioned adjacent the first side 32 of one or more fluxgate sensors 30, and a second magnet 25 may be positioned adjacent the second side 34 of one or more fluxgate sensors 30. The polarity of the first and second magnets 25 is generally reversed relative to one another. Similar to the tooth sensing device 20 of FIGS. 1 and 2, the position and strength of the magnets 25 relative to the fluxgate sensors 30 may be dynamically adjusted until the fluxgate output signals have high amplitude without system saturation.

The output signal generated by a fluxgate sensor 30 may become saturated if certain portions of the rotating component 40 have a magnetic field. An exemplary fluxgate output signal, illustrated in FIG. 7, includes a drop in amplitude as a result of this unwanted magnetic field acting on the teeth 45. In an embodiment, a current feedback loop (not shown) may be used to reduce the saturation limits of the fluxgate sensor 30. For example, if the average output of a circuit of the fluxgate sensor 30 is above or below 2.5 volts, a constant current is summed with an inner loop current at the 2.5 Vdc end of the fluxgate sensor 30. In an embodiment, the current feedback loop (not shown) has a time constant generally equal to the expected magnetic runout at the slowest operational speed of the rotating component 40.

In another embodiment, the robustness of the fluxgate output signal may be improved by making the rotating component 40 substantially magnetically uniform. At least one demagnetizing magnet 50, as illustrated in FIG. 8, is arranged near the outer periphery 42 of the rotating component 40. In embodiments including a plurality of magnets 50, the magnets 50 are radially spaced about the outer periphery 42 of the rotating component 40 and have alternating polarities to form an alternating current degaussing pattern. The magnets 50 are utilized to erase previous magnetic history that might have come from the manufacturing process or “hot spots” that can occur from unintentional placement of a magnet on the rotating component. Further, the magnets 50 may be utilized to magnetize the rotating component 40 with a fresh field just before it passes the sensor 30. The number of magnets 50 used may depend on the sensitivity of the fluxgate sensors 30 and the anticipated magnetic field to which the rotating component 40 may be exposed. In an embodiment, the magnets 50 are spaced away from the fluxgate sensor 30, for example opposite the fluxgate sensor 30 as illustrated in the FIG.

In another embodiment, an electronic detection circuit (not shown) including at least one detector 55 (see FIG. 9) is configured to use the speed of the rotating component 40, detected as the tooth passage frequency, to phase its method of detection to match an expected location of the teeth 45 based on the speed of the rotating component 40. Any suitable type of detector 55 may be used. The electronic circuitry connected to these detectors 55 is configured to synchronize the detection method to the passing of the teeth 45.

The one or more fluxgate sensors 30 may be arranged in any of a number of orientations relative to the rotating component 40 and the shaft 35 supporting the rotating component 40. When the fluxgate sensor 30 is positioned at the side of the rotating component 40, the fluxgate sensor 30 is more sensitive to the magnetic state of the teeth 45 and the webbing at the center of the rotating component 40. In an embodiment, the fluxgate sensors 30 are arranged generally perpendicular to and axially aligned with the teeth 45 of the rotating component 40 (see FIG. 10). In addition, the spacing between adjacent fluxgate sensors 30 may be generally equal to the spacing between a tooth 45 and an adjacent valley 48 between teeth 45, as shown in FIG. 11, to produce a fluxgate output signal having a high amplitude.

In an embodiment, the one or more fluxgate sensors 30 of the tooth sensing device 20 may be used as an inductive pickup configured to measure permeability rather than magnetic flux. Alternatively, the tooth sensing device 20 may use at least one fluxgate sensor 30 in a combined manner such that the electronic circuitry is configured to use a fluxgate sensor 30 exclusively as a fluxgate sensor, exclusively as an inductive pickup, or as a combination thereof. An exemplary circuit 60 configured to use an inductive pickup or a fluxgate sensor 30 configured as an inductive pickup is illustrated in FIG. 12.

With reference now to FIG. 13, a sinusoidal signal may be generated into a filter following the detector 55 as a further means of improving the tooth sensing signal. The connection between C12 and R11 has been broken to demonstrate the ripple on the output without the noise cancellation feature. In an embodiment, the inclusion of additional circuitry consisting of four passive components, R19, C14, R18, and C12 may result in a 10 to 1 reduction in output ripple.

Referring now to FIG. 14, a schematic of a fluxgate sensor 30 used as a tooth sensor in variable reluctance mode is illustrated. The fluxgate sensor 30 contains a high permeability core that amplifies the flux according to B=μH, where B is the magnetic flux density, H is the magnetic field density and μ is the permeability of the core. IN some embodiments, the core may be formed from a highly permeable material such as Permalloy (amorphous), typically having a bulk permeability of >10,000, compared to ferrite rod having a permeability of <1000. The core has a small volume, and in one embodiment measures about 0.010″ wide by 0.001″ thick by 0.50″ long, having a cross-sectional area of about 0.010 square mils. IT is to be appreciated that the dimensions of the core included here are merely exemplary, and that other sizes and configurations of cores may be utilized. In this embodiment, the coil wrapped around the core is 0.062″ in diameter by 0.50″ long (500 turns of #42 wire). That measures about 8 Ohms resistance, compared with 3000 Ohms for a typical variable reluctance sensing coil. The net result is a sensor 30 that weighs a few milligrams, rather than several 10's of grams. The fluxgate sensor 30 thus produces a flux Ø=BA, where A is a cross-sectional area of a fluxgate sensor coil. As teeth 45 rotate past the coil, a voltage is induced in the coil by the modulation of the H field. This, in turn, produces a modulated voltage expressed as shown in equation (1):

V=N*(dØ/dT)per Faraday's law. (1)

Where N is a number of turns in the coil, and
dØ/dT is a rate of change of the flux, which is proportional to the rotational velocity of the rotating component 40 and the number of teeth 45.

The voltage V is approximately a sinusoidal wave. The voltage V is then output to an amplifier, for example a differential amplifier as shown, or alternatively an instrumentation amplifier. At the amplifier, the voltage V is amplified by a selected gain factor and level shifted to be symmetric about Vdd/2. The voltage V remains sinusoidal in nature but has a greater amplitude than the pre-amplified voltage. It is then fed into a comparator with Vdd/2 as a threshold point. The comparator has a positive feedback resistor shown in FIG. 1 as 10R with an input resistor R, resulting in about a 10% hysteresis. This hysteresis prevents high frequency oscillations when the Vₒᵤₜ of the differential amplifier crosses over Vdd/2.

The resultant output Out+ is a ground referenced quasi square wave that is then fed into an electronic circuit where its phase is compared with another reference square wave of the same frequency. The core in the coil is a high permeability mu-metal alloy, e.g., a high magnetic permeability alloy such as an alloy of nickel, iron, copper, and chromium or molybdenum, that will saturate at some point causing a self limiting output voltage, unlike some variable reluctance sensors that have a linear, non-saturating core. The high permeability of the core material compared with other variable reluctance sensors allows for miniaturization of the detector and fewer turns of copper.

The fluxgate output signal from the one or more fluxgate sensors 30 of the tooth sensing device 20 may be used as an absolute position encoder such that the stopping position of the rotating component 40, such as a flexplate 40 of an engine for example, may be determined. The fluxgate output signal (or another tooth sensing method that does not require rotation to detect teeth 45) may be used to track the position of the teeth 45 as the rotating component 40 slows to a stop. Another input signal, such as a cam sensor signal for example, may be used to determine the position of the rotating component 40 within the engine cycle and once calibrated, each tooth 45 would be numbered and tracked as the engine stops. This information would be provided to a controller (not shown) or an engine control computer so that the absolute position of the shaft 35 supporting the rotating component 40 would be known. Such information would be useful, for example, for start-stop systems.

The tooth sensing device 20 and the method of sensing tooth position as described herein may be used for, but not limited to, angular speed measurement, distance traveled calculation, absolute position encoding, relative position encoding, and torque sensing. This is a more robust method of tooth sensing, as the system is less sensitive to the magnetic state of the flexplate (or alternatively the teeth of any toothed wheel).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. cm What is claimed is:

1. A rotational position sensing device comprising:
at least one sensor positioned adjacent a rotating component configured to rotate about an axis of rotation; and
at least one magnet positioned at the rotating component such that a magnetic field of the at least one magnet affects the sensor and magnetizes a portion of the rotating component, wherein the at least one sensor is configured to produce an output signal indicative of a magnetic flux, and therefore a position, of the rotating component.

2. The rotational position sensing device according to claim 1, wherein the rotating component includes a plurality of teeth extending about an outer periphery of the rotating component.

3. The rotational position sensing device according to claim 2, wherein the at least one sensor is arranged generally perpendicular to and axially aligned with the teeth of the rotating component.

4. The rotational position sensing device according to claim 3, wherein a spacing between a plurality of adjacent sensors is substantially equal to a spacing between a tooth of the plurality of teeth of the rotating component and an adjacent valley.

5. The rotational position sensing device according to claim 2, wherein at least one detector is positioned adjacent the rotating component.

6. The rotational position sensing device according to claim 5, wherein the at least one detector is configured to synchronize a detection method with the teeth of the rotating component.

7. The rotational position sensing device according to claim 1, wherein an axial and a vertical position of the at least one magnet relative to the at least one sensor varies based on a strength of the at least one magnet and a sensitivity of the at least one sensor.

8. The rotational position sensing device according to claim 1, further comprising a plurality of demagnetizing magnets positioned about an outer periphery of the rotating component, the demagnetizing magnets being configured to make the rotating component generally magnetically uniform.

9. The rotational position sensing device according to claim 8, wherein the plurality of demagnetizing magnets are positioned to have an alternating polarity to form an alternating current degaussing pattern.

10. The rotational position sensing device according to claim 1, wherein the at least one sensor is a fluxgate sensor.

11. The rotational position sensing device according to claim 1, wherein the at least one sensor is a fluxgate sensor configured as an inductive pickup.

12. The rotational position sensing device according to claim 1, wherein the at least one sensor is an inductive pickup.

13. The rotational position sensing device according to claim 1, wherein the rotating component is positioned axially between the at least one sensor and the at least one magnet.

14. The rotational position sensing device according to claim 1, wherein the at least one sensor is disposed at a first circumferential end of the rotating component, and the at least one magnet is disposed substantially 180 degrees away from the at least one sensor.

15. A method of sensing a position of a rotating component, the method comprising:
magnetizing a portion of a rotating component with a magnet;
measuring a magnetic flux of the rotating component as it rotates about an axis of rotation; and
generating an output signal indicative of the position of the rotating component.

16. The method according to claim 15, wherein the magnetic flux is measured using at least one sensor positioned adjacent the rotating component.

17. The method according to claim 15, wherein the at least one sensor is a fluxgate sensor.

18. The method according to claim 15, further comprising amplifying the measured magnetic flux to produce an amplified output signal.
